(19) United States
(12) Patent Application Publication
(10) Pub. No.: US 2013/0080892 A1
(43) Pub. Date: Mar. 28, 2013

(54) INFORMATION PROCESSING DEVICE, GUI MANIPULATION ASSISTANCE METHOD, AND COMPUTER-READABLE RECORDING MEDIUM

(71) Applicant: Sumitaka Okajo, Tokyo (JP)

(72) Inventor: Sumitaka Okajo, Tokyo (JP)

(73) Assignee: NEC CORPORATION, Tokyo (JP)

(21) Appl. No.: 13/700,374

(22) PCT Filed: Apr. 5, 2011
(86) PCT No.: PCT/JP2011/058634

§ 371 Date: Nov. 27, 2012

(30) Foreign Application Priority Data
May 28, 2010 (JP) 2010-122316

(51) Int. Cl. G06F 3/048

(52) U.S. Cl. 715/708

(57) ABSTRACT

An information processing device (201) comprises: a manipulation detection part (20) configured to detect a GUI manipulation that is a manipulation to a GUI of a first system; a mistaken manipulation history determination part (60), from among mistaken manipulation procedures that are past mistaken manipulation procedures to GUIs of one or more second systems, configured to acquire said mistaken manipulation procedure including a corresponding GUI manipulation that is a GUI manipulation in said second system corresponding to a target GUI manipulation that is said GUI manipulation detected by said manipulation detection part (20); and a corresponding-manipulation acquisition part (70) configured to extract a GUI manipulation in said second system after said corresponding GUI manipulation from said mistaken manipulation procedure acquired by said mistaken manipulation history determination part (60), and configured to acquire a GUI manipulation in said first system corresponding to extracted said GUI manipulation.

### TECHNICAL FIELD

The present invention relates to an information processing device, a GUI manipulation assistance method and a computer-readable recording medium, and in particular, to an information processing device, GUI manipulation assistance method and computer-readable recording medium for assisting a user who manipulates a GUI.

### BACKGROUND ART

Presently, a user uses a large variety of and a large number of applications accompanied by GUIs (Graphical User Interface) on a PC (Personal Computer). In addition, there are also many applications having the same functions and the same purposes, and furthermore, each application goes on performing a version upgrade at each timing in many cases.

In a case like this, since arrangements of manipulation components, i.e., a menu, a button and the like on a GUI differ depending on applications, a user may get confused at operation of applications, decrease an manipulating efficiency, and commit a mistaken manipulation.

In order to cope with such problems, a GUI manipulation assistance system for assisting a user who manipulates GUIs is required. An example of a conventional GUI manipulation assistance system has been disclosed in Japanese Patent Laid Open No. H8-147243 (Patent Document 1). That is, in this conventional GUI manipulation assistance system, with respect to each of a plurality of GUIs which achieves substantially the same functions although metaphors thereof are different, a server is provided with a storage part which stores information for realizing each GUI at a terminal device side, and with a control part which reads information for realizing the specified GUI from the above-mentioned storage part and transmits it to the above-mentioned terminal device in response to a GUI change request from a terminal device. In addition, the above-mentioned terminal device is provided with an execution part which configures a GUI realized by the received information on the self terminal device, and accepts a manipulation from a user through the GUI.

In addition, on the ground that facility of a button manipulation is one which differs and changes for every user, a method for making a button manipulation be able to be carried out in an optimal state for every user has been disclosed in Japanese Patent Laid Open No. H8-129469 (Patent Document 2). That is, upon displaying on a display device manipulation buttons constituted of a button group which is an aggregation of buttons and a button class which presides over the button group, a display order and size of a manipulation button are made to be changed to be displayed based on a selection frequency of a button, a data value corresponding to a button, and arbitrary specification by a user.

In addition, in Japanese Patent No. 3633415 (Patent Document 3), the following method has been disclosed. That is, with a use application of software registered in advance, the use application is made to be displayed in a menu form on a display screen, and when the use application is selected on the menu, processes in which GUI parts to be manipulated next are displayed in a display form which is conspicuous from other on the screen are performed one by one in accordance with a manipulation procedure registered in advance. Thereby, as to arbitrary software having GUIs, even a beginner user is made to be able to use this software immediately.

In addition, in Japanese Patent Laid Open No. 2005-202500 (Patent Document 4), the following technology has been disclosed. That is, a manipulation method configuring program for configuring a manipulation method of a manipulation part makes a computer execute a manipulation history holding step which stores past manipulations of a user, and a presenting step which presents to a user configuration contents of the manipulation method with reference to the manipulation history stored in the above-mentioned manipulation history holding step in the case where a user changes the configuration of the manipulation method of the above-mentioned manipulation part. Then, a computer is made to execute further a mistaken manipulation history holding step which stores mistaken manipulation of a user, and in the case where a user changes the configuration of the manipulation method of the above-mentioned manipulation part, configuration contents of the manipulation method are presented to a user with reference to the mistaken manipulation of a user stored by the above-mentioned mistaken manipulation history holding step.

In addition, in Japanese Patent No. 4153980 (Patent Document 5), the following technology has been disclosed. That is, an electronic apparatus which operates with two or more types of manipulation targets switched is comprised of: a storage part which stores a database including data of a guidance sentence with respect to a switching manipulation of the manipulation target and data of a guidance sentence with respect to an execution manipulation of a function assigned to each manipulation object; a detection part which detects switching of the manipulation target; a table generation part which creates a table based on the above-mentioned database in response to the detection of the switching of the above-mentioned manipulation target, in which in the above-mentioned table, each function of the above-mentioned manipulation target is categorized into a common function which is executed in common with the manipulation target before and after a switching manipulation, and an individual function which is not executed in common; a determination part which determines that a confirmation message with respect to the switching of the manipulation target is presented in the case where a function instructed of execution by a user belongs to the above-mentioned common function, and determines that the above-mentioned confirmation message and a confirmation message with respect to the above-mentioned function instructed of are presented in the case where a function instructed of execution by a user belongs to the above-mentioned individual function; and an outputting part which outputs a presenting signal for presenting the above-mentioned confirmation messages. The above-mentioned storage part stores further an accuracy rate database in which a plurality of functions which output confirmation messages are associated with an accuracy rate for each of a plurality of above-mentioned functions, and the above-mentioned updating part acquires an accuracy rate corresponding to the function updated so as to indicate that the above-mentioned confirmation message is not made to be presented with reference to the above-mentioned accuracy rate database, and changes the corresponding above-mentioned function flag so as to indicate that a confirmation message is not made to be presented for the functions associated with accuracy rates not less than the acquired above-mentioned accuracy rate among a plurality of above-mentioned functions specified in the above-mentioned accuracy rate database.

### PRIOR ART DOCUMENT

### Patent Documents

Patent Document 1: Japanese Patent Laid Open No. H8-147243
Patent Document 2: Japanese Patent Laid Open No. H8-129469

### Patent Document 3: Japanese Patent No. 3633415

### Patent Document 4: Japanese Patent Laid Open No. 2005-202500

### Patent Document 5: Japanese Patent No. 4153980

### SUMMARY OF THE INVENTION

### Problem to be Solved by the Invention

However, in a system described in Patent Document 1, while it is possible for a user to select a GUI which is considered to be easy to be manipulated, an application provider side must prepare a plurality of GUIs in advance, and a process becomes complicated.

In addition, in the system described in Patent Document 1, it is impossible to assist a user so that the user may not commit from now on the mistaken manipulation which has been actually committed by the user. The reason is as follows. That is, in the system described in Patent Document 1, the application provider side prepares a plurality of GUIs in advance assuming GUIs which is considered to be easy to be manipulated so that the user may not commit a mistaken manipulation. Consequently, it is because it is impossible to assist a user so that the user may not commit from now on the mistaken manipulation which has been actually committed by the user, and it is because it has assisted the user for a mistaken manipulation which will not be committed actually.

In addition, in a method described in Patent Document 2, while it is possible to change an arrangement and size of manipulation components for every user, it has not been taken into consideration to assist a manipulation to corresponding GUIs among a plurality of systems.

In addition, also in technologies described in Patent Documents 4 and 5, it has not been taken into consideration to assist a manipulation to corresponding GUIs among a plurality of systems.

That is, in the technologies described in Patent Documents 2, 4, and 5, since only a manipulation assistance in one system is taken into consideration, it is impossible to assist a manipulation to corresponding GUIs among a plurality of systems.

In addition, in a method described in Patent Document 3, it is necessary to register a use application and a manipulation procedure thereof in advance for every software program, and a process may become complicated.

The present invention has been accomplished for solving the above-mentioned problems, and the object is to provide an information processing device, a GUI manipulation assistance method, and a computer-readable recording medium which are capable of assisting a manipulation to corresponding GUIs among a plurality of systems in a simple process and satisfactorily.

### Means for Solving the Problems

For solving the problems mentioned above, an information processing device according to an aspect of the present invention is the information processing device for assisting a user who manipulates a GUI (Graphical User Interface), comprising: a manipulation detection part configured to detect a GUI manipulation that is a manipulation to a GUI of a first system; a mistaken manipulation history memory part configured to store one or more types of mistaken manipulation procedures that are past mistaken manipulation procedures to GUIs of one or more second systems; a mistaken manipulation history determination part configured to acquire above-mentioned mistaken manipulation procedure including a corresponding GUI manipulation that is a GUI manipulation in above-mentioned second system corresponding to a target GUI manipulation that is above-mentioned GUI manipulation detected by above-mentioned manipulation detection part from among above-mentioned one or more types of mistaken manipulation procedures which above-mentioned mistaken manipulation history memory part stores; and a corresponding-manipulation acquisition part configured to extract a GUI manipulation in above-mentioned second system after above-mentioned corresponding GUI manipulation from above-mentioned mistaken manipulation procedure acquired by above-mentioned mistaken manipulation history determination part, and configured to acquire a GUI manipulation in above-mentioned first system corresponding to extracted above-mentioned GUI manipulation.

For solving the problems mentioned above, a GUI manipulation assistance method according to an aspect of the present invention is the GUI manipulation assistance method which assists a user who manipulates a GUI of a first system, comprising the steps of : storing one or more types of mistaken manipulation procedures that are past mistaken manipulation procedures to GUIs of one or more second systems; detecting a GUI manipulation that is a manipulation to a GUI of above-mentioned first system; acquiring above-mentioned mistaken manipulation procedure including a corresponding GUI manipulation that is a GUI manipulation in above-mentioned second system corresponding to a target GUI manipulation that is detected above-mentioned GUI manipulation, from among stored above-mentioned one or more types of mistaken manipulation procedures; and extracting a GUI manipulation in above-mentioned second system after above-mentioned corresponding GUI manipulation from acquired above-mentioned mistaken manipulation procedure, and acquiring a GUI manipulation in above-mentioned first system corresponding to extracted above-mentioned GUI manipulation.

For solving the problems mentioned above, a computer-readable recording medium according to an aspect of the present invention is the computer-readable recording medium in which a GUI manipulation assistance program used in an information processing device for assisting a user who manipulates a GUI of a first system is recorded, above-mentioned GUI manipulation assistance program being a program making a computer execute the steps of: storing one or more types of mistaken manipulation procedures that are past mistaken manipulation procedures to GUIs of one or more second systems; detecting a GUI manipulation that is a manipulation to a GUI of above-mentioned first system; acquiring above-mentioned mistaken manipulation procedure including a corresponding GUI manipulation that is a GUI manipulation in above-mentioned second system corresponding to a target GUI manipulation that is detected above-mentioned GUI manipulation, from among stored above-mentioned one or more types of mistaken manipulation procedures; and extracting a GUI manipulation in above-mentioned second system after above-mentioned corresponding GUI manipulation from among acquired above-mentioned mistaken manipulation procedure, and acquiring a GUI manipulation in above-mentioned first system corresponding to extracted above-mentioned GUI manipulation.

### EFFECT OF THE INVENTION

According to the present invention, a manipulation to corresponding GUIs among a plurality of systems can be assisted in a simple process and satisfactorily.

### BRIEF DESCRIPTION OF THE DRAWINGS

FIG. 1 is a schematic configuration diagram of a linkage information output apparatus according to a first embodiment of the present invention;

FIG. 2 is a block diagram showing control structures which the information processing device according to the first embodiment of the present invention provides and peripheral configurations of the information processing device according to the first embodiment of the present invention.

FIG. 3 is a flow chart showing a operation procedure in the case where an information processing device according to the first embodiment of the present invention accumulates the manipulation history.

FIG. 4 is a figure showing a GUI screen of an e-mail application Mail A which is an example of the target system.

FIG. 5 is a figure showing an example of manipulation history information which the manipulation history memory part 21 stores.

FIG. 6 is a flow chart showing a operation procedure in the case where the information processing device according to the first embodiment of the present invention detects a mistaken manipulation.

FIG. 7 is a figure showing an example of the mistaken manipulation pattern table which the mistaken manipulation pattern memory part 30 stores.

FIG. 8 is a figure showing an example of the GUI which the e-mail application Mail A provides.

FIG. 9 is a figure showing an example of the mistaken manipulation information stored in the mistaken manipulation history memory part 41.

FIG. 10 is a flow chart showing a operation procedure in the case where the information processing device according to the first embodiment of the present invention assists a user's GUI manipulation.

FIG. 11 is a figure showing an example of a manipulation component information table.

FIG. 12 is a figure showing an example of a GUI which the e-mail application Mail B provides.

FIG. 13 is a figure showing an example of a GUI which the e-mail application Mail B provides.

FIG. 14 is a figure showing an example of highlighting the manipulation component in the information processing device according to the first embodiment of the present invention.

FIG. 15 is a flow chart showing a operation procedure in the case where the information processing device according to the second embodiment of the present invention detects a mistaken manipulation.

### BEST MODES FOR CARRYING OUT THE INVENTION

Hereinafter, an embodiment of the present invention will be described using the figures. It is noted that the same reference character will be given to the same or corresponding part in the figures, and thus the description will not be repeated.

### First Embodiment

### SUMMARY

In an information processing device according to a first embodiment of the present invention, a mistaken manipulation history determination part determines, in association with user's manipulation to a GUI of a system which the user operates at present (hereinafter, referred to, also, as a target system), whether a mistaken manipulation to GUIs of systems other than the target system has existed or not.

Here, systems other than the target system means one or more of systems having functions similar to the target system, and systems which are different from the target system in a version thereof are also included. For example, in the case where a system called a web browser is considered, when the target system is an IE (Internet Explorer) 7, systems other than the target system will be an 1E8, Firefox, Safari, Google Chrome, or the like.

A corresponding-manipulation component determination part, in the case where it is determined that a mistaken manipulation has existed as a result of the above-mentioned determination, determines the manipulation component becoming a factor resulting in a mistaken manipulation on the GUI of the target system. A corresponding-manipulation component display part displays the determined manipulation component in a highlighted manner so that a user may identify it.

Base on such configurations, in the case where there exist mistaken manipulations which have been committed to GUIs of applications which a user has not used until now, GUIs of systems which are of the same kind but different each other, or GUIs of systems which are the same but of another version, the user can be assisted so as not to commit the same mistaken manipulation while manipulating a GUI of a certain system. Thereby, the object of the present invention to assist a manipulation to corresponding GUIs among a plurality of systems in a simple process and satisfactorily can be achieved.

The information processing device according to the first embodiment of the present invention, typically, includes a computer which has a general-purpose architecture as a basic structure, and provides various functions described later by executing a program installed in advance. Generally, a program like this circulates in a state of being stored in a recording medium such as a flexible disk (Flexible Disk) and a CD-ROM (Compact Disk Read Only Memory), or via a network, etc. In the case where a general-purpose computer like this is used, in addition to an application for providing functions according to the first embodiment of the present invention, an OS (Operating System) for providing a fundamental function of the computer may be installed. In this case, a program according to the first embodiment of the present invention may be what executes processing by calling a required module in a prescribed order and/or timing within program modules provided as a part of the OS. That is, a program itself according to the first embodiment of the present invention may not include above modules, and processing may be executed by collaborating with the OS. Therefore, as a program according to the first embodiment of the present invention, it may have a configuration which does not include modules as mentioned above.

Furthermore, a program according to the first embodiment of the present invention may be provided with being incorporated in a part of other programs such as an OS. Also in this case, a program itself according to the first embodiment of the present invention does not include modules which other programs of the incorporation destination have as mentioned above, and the processing is executed by collaborating with the other programs. That is, as a program according to the first embodiment of the present invention, it may have a configuration which is incorporated in other programs like this.

Besides, alternatively, a part or all of functions which are provided by the program execution may be implemented as dedicated hardware circuitry.

### [Apparatus Configuration]

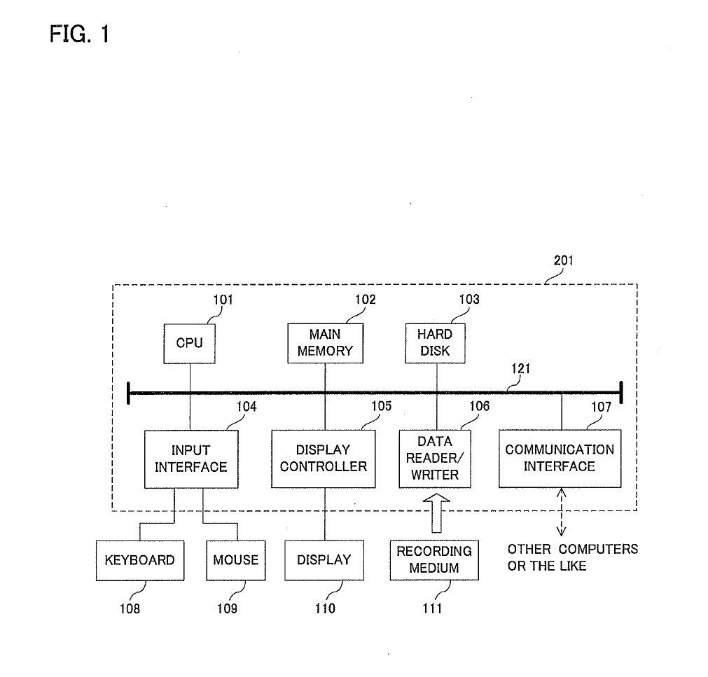

FIG. 1 is a schematic configuration diagram of a information processing device according to the first embodiment of the present invention. With reference to FIG. 1, a information processing device 201 is an information processing apparatus such as a portable information terminal, a personal computer and a server, and comprises: a CPU(Central Processing Unit) 101 which is an arithmetic processing unit; a main memory 102 and a hard disk 103; an input interface 104; a display controller 105; a data reader/writer 106; and a communication interface 107. Each of these parts is connected in a manner where data communication is possible mutually via a bus 121.

The CPU101 carried out various calculations by reading out programs (code) stored in the hard disk 103 and writing to the main memory 102, and executing these in prescribed order. The main memory 102 typically is a volatile storage device such as a DRAM (Dynamic Random Access Memory), and holds data etc. which indicate various arithmetic processing results in addition to programs read from the hard disk 103.

The hard disk 103 is nonvolatile magnetic storage device, and various setting values etc. are stored in addition to the programs executed by the CPU101. Programs installed on this hard disk 103 circulate in a state of being stored in a recording medium 111 as described later. Besides, in addition to the hard disk 103, or in place of the hard disk 103, a semiconductor memory such as a flash memory may be adopted.

The input interface 104 intermediates data transmission between the CPU101 and a keyboard 108, a mouse 109 and an input unit such as a touch panel which is not illustrated. That is, the input interface 104 accepts an input from the outside, such as operation command given by a user operating the input unit.

The display controller 105 is connected with a display 110 which is a typical example of a display unit, and controls display on the display 110. That is, the display controller 105 displays to a user a result or the like of image processing by the CPU101. The display 110 is a LCD (Liquid Crystal Display) or a CRT (Cathode Ray Tube), for example.

The data reader/writer 106 intermediates data transmission between the CPU101 and the recording medium 111. That is, the recording medium 111 circulates in a state where programs etc. executed by the information processing device 201 is stored, and the data reader/writer 106 reads the programs from this recording medium 111. The data reader/writer 106, in response to an internal command of the CPU101, writes a processing result, etc. in the information processing device 201 to the recording medium 111. Besides, the recording medium 111 is, for example, a general-purpose semiconductor storage device such as a CF (Compact Flash) and a SD (Secure Digital), a magnetic storage medium such as a flexible disk (Flexible Disk), or an optical storage medium such as a CD-ROM (Compact Disk Read Only Memory).

The communication interface 107 intermediates data transmission between the CPU101 and a personal computer, a server device or the like. The communication interface 107, typically, has a communication function of Ethernet® or a USB (Universal Serial Bus). Besides, in place of a configuration where programs stored in the recording medium 111 are installed on the information processing device 201, programs downloaded from a distribution server etc. via the communication interface 107 may be installed on the information processing device 201.

To the information processing device 201, other output apparatuses, such as a printer, may be connected as necessary.

### [Control Structure]

Then, a control structure for providing various functions in an information processing device 201 will be described.

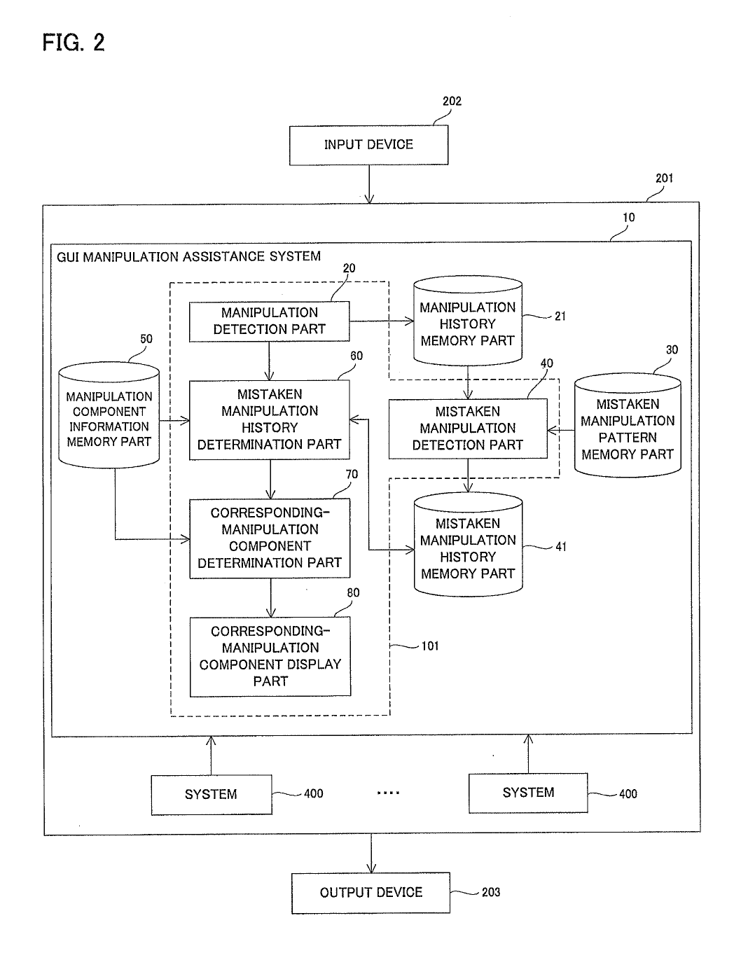

FIG. 2 is a block diagram showing control structures which the information processing device according to the first embodiment of the present invention provides and peripheral configurations of the information processing device according to the first embodiment of the present invention. Each block in a GUI manipulation assistance system constituted by the information processing device shown in FIG. 2 is provided by developing program (code) or the like stored in a hard disk 103 to a main memory 102 and by making a CPU 101 execute it. Besides, a part or all of modules shown in FIG. 2 may be provided with firmware implemented in hardware. Alternatively, a part or all of control structures shown in FIG. 2 may be realized with dedicated hardware and/or a wiring circuit.

With reference to FIG. 2, the information processing device 201 is comprised of the CPU101, a manipulation history memory part 21, a mistaken manipulation pattern memory part 30, a mistaken manipulation history memory part 41, and a manipulation component information memory part 50. The CPU 101 includes, as the control structures, a manipulation detection part 20, a mistaken manipulation detection part 40, a mistaken manipulation history determination part 60, a corresponding-manipulation component determination part (corresponding manipulation acquisition part) 70, and a corresponding-manipulation component display part 80. The manipulation history memory part 21, the mistaken manipulation pattern memory part 30, the mistaken manipulation history memory part 41, and the manipulation component information memory part 50 correspond to the main memory 102 or the hard disk 103 shown in FIG. 1.

Although the CPU 101 generally is constituted of many units in addition to each part shown in FIG. 2, a unit which is not related to the present invention is not shown for making description simple.

The information processing device 201 is comprised of a GUI manipulation assistance system 10. That is, the GUI manipulation assistance system 10 is constituted of the manipulation detection part 20, the manipulation history memory part 21, the mistaken manipulation pattern memory part 30, the mistaken manipulation detection part 40, the mistaken manipulation history memory part 41, the manipulation component information memory part 50, the mistaken manipulation history determination part 60, the corresponding-manipulation component determination part 70, and the corresponding-manipulation component display part 80. The GUI manipulation assistance system 10 is a system which displays manipulation assistance information of a GUI of each system 400 on an output device 203.

In addition, the information processing device 201 is comprised of a plurality of systems 400. Each system 400 is another system other than the GUI manipulation assistance system 10, and it is constituted by that the information processing device 201 executes programs such as application programs.

The GUI manipulation assistance system 10 is connected to an input device 202 and the output device 203 via the information processing device 201. The input device 202 is a device for a user to input a manipulation to the information processing device 201. As the input device 202, input devices such as a keyboard and a mouse are included, for example. A user, using the input device 202, can perform a manipulation to systems 400 constituted on the information processing device 201. The input device 202 corresponds to a keyboard 108 and a mouse 109 which are shown in FIG. 1.

The output device 203 is a display device provided with a display screen, for example, and displays a GUI which the system 400 constituted on the information processing device 201 outputs. The output device 203 corresponds to a display 110 shown in FIG. 1.

The manipulation detection part 20 detects manipulation contents which a user has performed to the GUI of the system 400 displayed on the screen of the output device 203. For example, the manipulation detection part 20 detects to which system GUI and to which manipulation component a user has performed a manipulation.

Here, the manipulation to a GUI (hereinafter, also referred to as a GUI manipulation) means to perform an instruction to the system 400 which displays the GUI by performing each button depression, menu selection and the like on manipulation components such as a button and menu on the GUI.

In addition, the manipulation detection part 20 outputs manipulation information indicating detected manipulation contents to the manipulation history memory part 21. The manipulation history memory part 21 stores the manipulation information received from the manipulation detection part 20.

The mistaken manipulation pattern memory part 30 has stored a mistaken manipulation pattern indicating various examples of mistaken manipulation procedures to the GUI of each system 400. In more details, the mistaken manipulation pattern memory part 30 stores a mistaken manipulation pattern used for detecting a mistaken manipulation which a user has actually committed from among user's manipulation histories which the manipulation history memory part 21 stores, specifically a mistaken manipulation pattern table. The mistaken manipulation pattern table has, as described later, a mistaken manipulation procedure configured in advance for every system 400 defined as a mistaken manipulation pattern.

The mistaken manipulation detection part 40 detects a mistaken manipulation which a user actually committed from manipulation histories which manipulation history memory part 21 stores, for example. In more details, the mistaken manipulation detection part 40, with reference to manipulation histories which the manipulation history memory part 21 stores and the mistaken manipulation pattern table stored in the mistaken manipulation pattern memory part 30, specifies the manipulation history conforming to the mistaken manipulation pattern, and thereby, detects the mistaken manipulation.

Then, the mistaken manipulation detection part 40 outputs to the mistaken manipulation history memory part 41 the conformed mistaken manipulation pattern, i.e., the mistaken manipulation information indicating the mistaken manipulation procedure. The mistaken manipulation history memory part 41 stores the mistaken manipulation information received from the mistaken manipulation detection part 40.

The manipulation component information memory part 50 has stored information for specifying manipulation components of the GUI of each system 400 displayed on a screen of the output device 203. For example, the manipulation component information memory part 50 stores a type of a manipulation component, a label string, a window where manipulation components are arranged, and a manipulation component information table indicating a label of a menu in which manipulation components are arranged for every system type and for every manipulation content.

In addition, the manipulation detection part outputs manipulation information indicating the detected manipulation contents also to the mistaken manipulation history determination part 60.

The mistaken manipulation history determination part 60, for example, using the manipulation information with respect to the GUI of the target system received from the manipulation detection part 20, with reference to the manipulation component information table stored in the manipulation component information memory part 50, acquires manipulation components of systems 400 other than the target system, which corresponds to the manipulation components of the target system which the above-mentioned manipulation information indicates.

Furthermore, the mistaken manipulation history determination part 60, with reference to the mistaken manipulation information which the mistaken manipulation history memory part 41 stores, determines whether the mistaken manipulation information indicating the mistaken manipulation procedure having as a starting point the manipulation to the acquired manipulation component exists in the mistaken manipulation history memory part 41. The mistaken manipulation history determination part 60, in the case where the mistaken manipulation information exists as a result of the determination, outputs the mistaken manipulation information to the corresponding-manipulation component determination part 70.

The corresponding-manipulation component determination part 70, from the mistaken manipulation procedure which the mistaken manipulation information received from the mistaken manipulation history determination part 60 indicates, extracts manipulation components becoming targets of manipulations after the manipulation becoming the starting point of the mistaken manipulation.

Furthermore, the corresponding-manipulation component determination part 70, with reference to the manipulation component information table stored in the manipulation component information memory part 50, retrieves the manipulation component on the GUI of the target system corresponding to the extracted manipulation components. Then, the corresponding-manipulation component determination part 70 outputs the manipulation component information indicating the retrieved manipulation component to the corresponding-manipulation component display part 80.

The corresponding-manipulation component display part 80 displays the manipulation component on the GUI of the target system which the manipulation component information received from the corresponding-manipulation component determination part 70 indicates in a highlighted manner so that a user may not have operated it accidentally.

### [Operation]

Then, a operation of the information processing device according to the first embodiment of the present invention will be described using figures. In the first embodiment of the present invention, a GUI manipulation assistance method according to the first embodiment of the present invention is carried out by operating the information processing device 201. Therefore, descriptions of the GUI manipulation assistance method according to the first embodiment of the present invention are substituted with following manipulation descriptions of the information processing device 201. Besides, in the following descriptions, FIG. 2 is referred to suitably.

### [Acquisition of Mistaken Manipulation History]

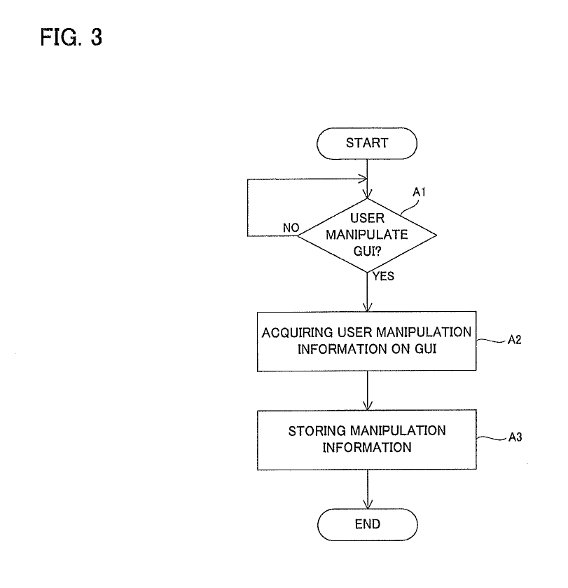

First, using FIG. 3, a operation in which a manipulation which a user has performed to the GUI of the target system is detected and the manipulation history is accumulated will be described.

FIG. 3 is a flow chart showing a operation procedure in the case where an information processing device according to the first embodiment of the present invention accumulates the manipulation history.

With reference to FIG. 3, the manipulation detection part 20 monitors the information processing device 201, and detects manipulations which a user has performed to the GUI of the target system via the input device 202 (Step A1).

The manipulation detection part 20, in the case where a user does not perform a manipulation to the GUI (NO at Step A1), will be in a standby state, and continues monitoring of the information processing device 201 further.

On the other hand, the manipulation detection part 20, in the case where a user has performed the manipulation to the GUI (YES at Step A1), detects the user's GUI manipulation, and acquires the manipulation information indicating the GUI manipulation (Step A2).

Then, the manipulation detection part 20 stores the acquired manipulation information in the manipulation history memory part 21 (Step A3).

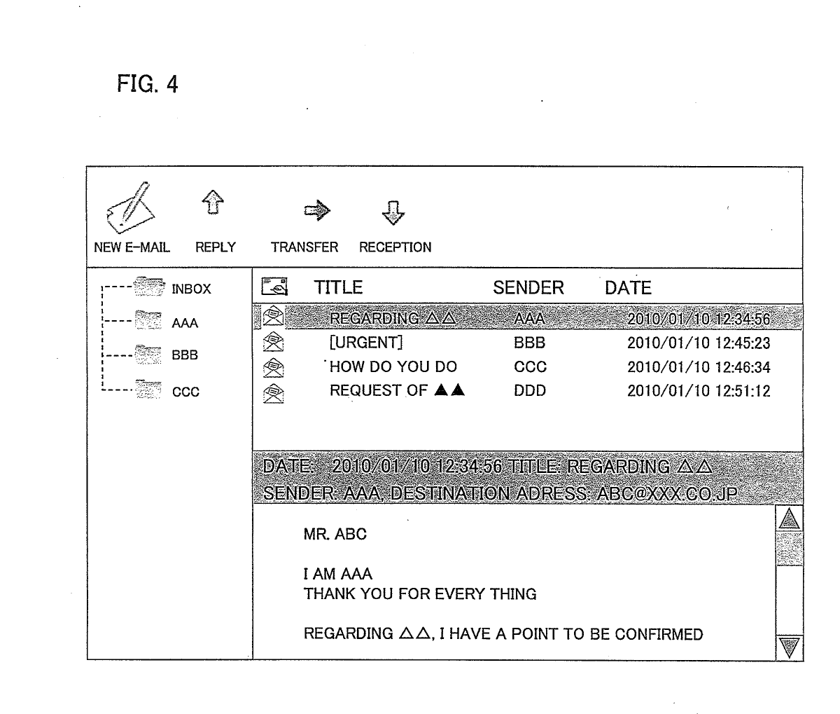

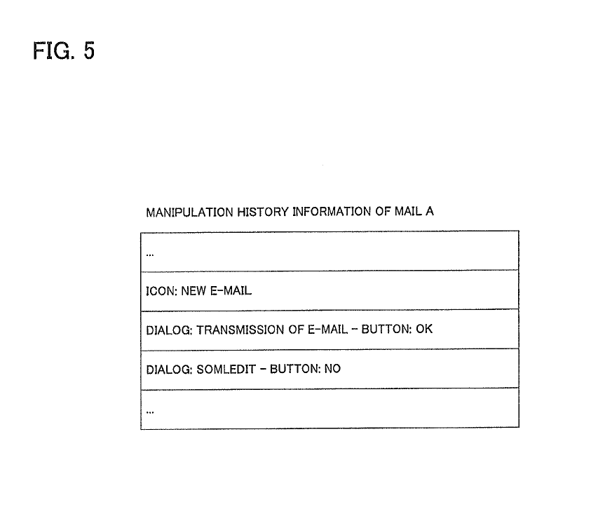

Then, the above-mentioned manipulation information will be described using FIG. 4 and FIG. 5.

FIG. 4 is a figure showing a GUI screen of an e-mail application Mail A which is an example of the target system.

With reference to FIG. 4, a user, to the GUI of the e-mail application Mail A for example, carries out a manipulation in which the “ “New e-mail” icon button” which exists in a tool bar is depressed using a mouse which is the input device 202. Then, the manipulation detection part 20 detects the GUI manipulation, and acquires “Icon: New e-mail” as the manipulation information, and stores the acquired manipulation information in the manipulation history memory part 21. The manipulation detection part 20, whenever detecting a user's GUI manipulation, stores the manipulation information indicating the manipulation contents in the manipulation history memory part 21.

FIG. 5 is a figure showing an example of manipulation history information which the manipulation history memory part 21 stores.

With reference to FIG. 5, in the manipulation history memory part 21, “Dialog: Transmission of an e-mail—Button: OK” or the like is stored as a manipulation information other than the above-mentioned “Icon: New e-mail”. Here, “Dialog: Transmission of an e-mail—Button: OK” indicates that the “OK” button on a dialog having a title “Transmission of an e-mail” has been depressed.

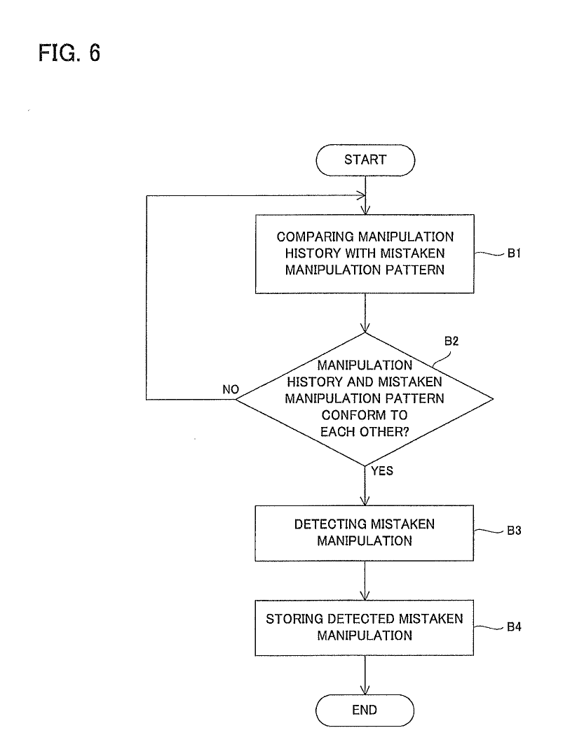

Then, a operation in which a mistaken manipulation is detected from a manipulation history using FIG. 6 will be described.

FIG. 6 is a flow chart showing a operation procedure in the case where the information processing device according to the first embodiment of the present invention detects a mistaken manipulation.

With reference to FIG. 6, the mistaken manipulation detection part 40 compares the manipulation history stored in the manipulation history memory part 21 with mistaken manipulation patterns stored in the mistaken manipulation pattern memory part 30 (Step B1).

Here, the mistaken manipulation pattern memory part 30 stores for every system 400 in advance various patterns of mistaken manipulations in a GUI manipulation. The mistaken manipulation pattern is defined as a manipulation procedure of a manipulation component on a GUI.

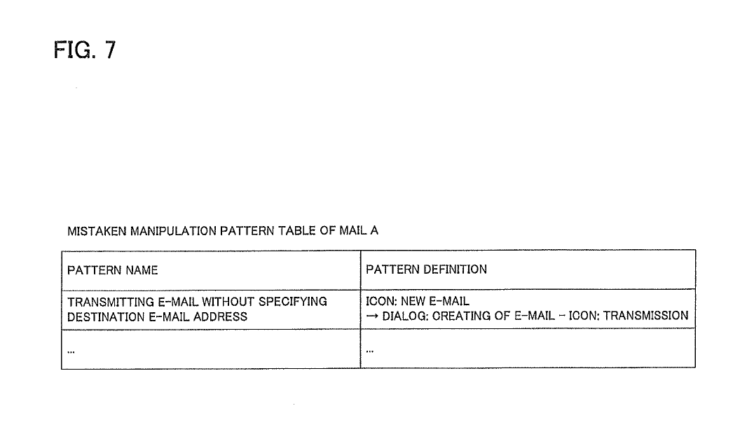

FIG. 7 is a figure showing an example of the mistaken manipulation pattern table which the mistaken manipulation pattern memory part 30 stores.

With reference to FIG. 7, the mistaken manipulation pattern table is prepared for every system 400, and in each table, a mistaken manipulation pattern is defined as a manipulation procedure.

That is, a mistaken manipulation pattern of carrying out “transmitting without specifying a destination e-mail address” in the e-mail application Mail A is defined as a manipulation procedure “Icon: New e-mail→Dialog: Creating an e-mail—Icon: Transmission”.

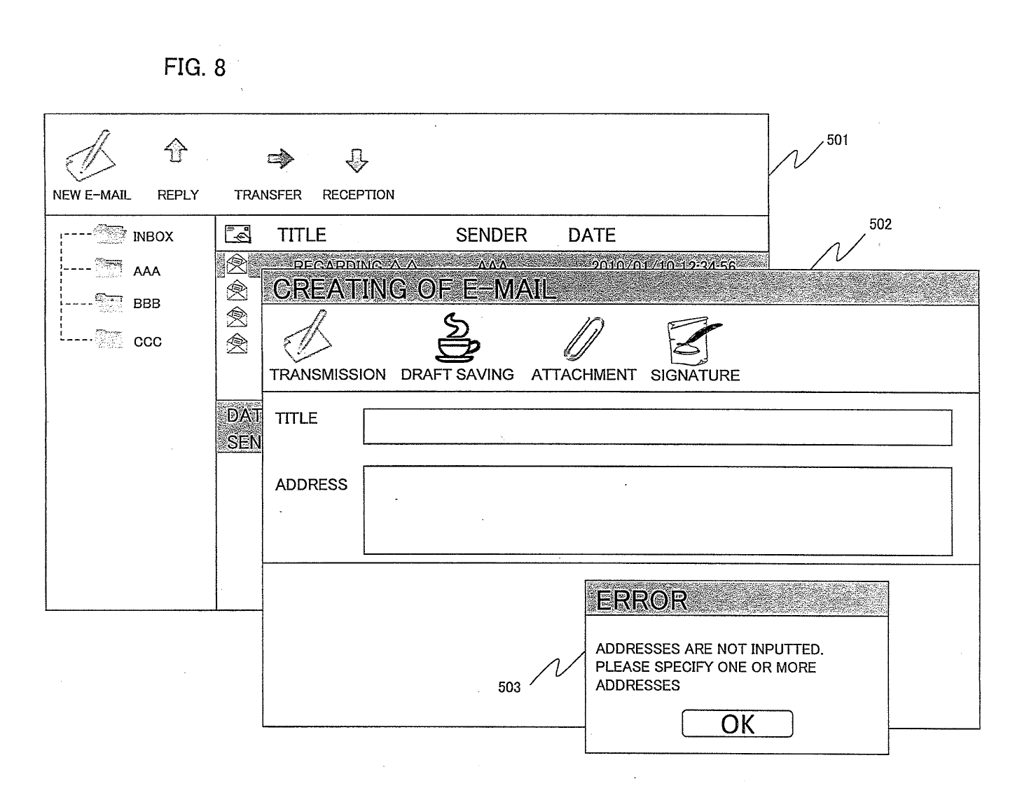

Then, using FIG. 8, the actual contents of mistaken manipulation patterns indicated in FIG. 7 as examples will be described.

FIG. 8 is a figure showing an example of the GUI which the e-mail application Mail A provides.

With reference to FIG. 8, first, a user depresses a “New e-mail” icon button existing on a tool bar in a main screen 501 of the GUI provided by the e-mail application Mail A, which is displayed on the screen of the output device 203, using a mouse or the like which is the input device 202.

Then, a “Creating an e-mail” dialog 502 is displayed on the screen of the output device 203.

Then, as a correct manipulation procedure, a user, after writing-in a title, a destination e-mail address, and a text on the “Creating an e-mail” dialog 502 using a keyboard or the like which is the input device 202, depresses a “Transmission” icon button to transmit the e-mail.

However, in the mistaken manipulation pattern table indicated in FIG. 7, the mistaken manipulation pattern of depressing the “Transmission” icon button without writing-in the destination e-mail address has been defined.

This mistaken manipulation pattern corresponds to the mistaken manipulation that a destination e-mail address required for transmission of an e-mail is not specified, and the e-mail application Mail A displays an error dialog 503.

Again with reference to FIG. 6, then, the mistaken manipulation detection part 40, for example, compares the manipulation history of the e-mail application Mail A indicated in FIG. 5 which is stored in the manipulation history memory part 21 with the mistaken manipulation pattern in the mistaken manipulation pattern table of the e-mail application Mail A indicated in FIG. 7, which is stored in the mistaken manipulation pattern memory part 30, and determines whether both conform to each other, i.e., whether a mistaken manipulation exists in the above-mentioned manipulation history (Step B2).

The mistaken manipulation detection part 40, in the case where the above-mentioned manipulation history and the above-mentioned mistaken manipulation pattern do not conform to each other, and where the mistaken manipulation does not exist in the manipulation history (NO at Step B2), will be in a standby state and continue the comparison further.

On the other hand, the mistaken manipulation detection part 40, in the case where the manipulation history and the mistaken manipulation pattern conform to each other, and the mistaken manipulation exists in the manipulation history (YES at Step B2), detects a mistaken manipulation of the user, and acquires mistaken manipulation information indicating the conformed mistaken manipulation pattern, i.e., the mistaken manipulation procedure (Step B3).

For example, in the case of examples shown in FIG. 5 and FIG. 7, the mistaken manipulation detection part 40 detects that the manipulation history and the mistaken manipulation procedure which is the mistaken manipulation pattern “Icon: New e-mail→Dialog: Creating an e-mail—Icon: Transmission” conform to each other. That is, the mistaken manipulation detection part 40 detects that a user has actually committed the mistaken manipulation of “transmitting without specifying a destination e-mail address” in the manipulation of the e-mail application Mail A.

Then, the mistaken manipulation detection part 40 stores the detected mistaken manipulation, i.e. stores the acquired mistaken manipulation information in the mistaken manipulation history memory part 41 (Step B4).

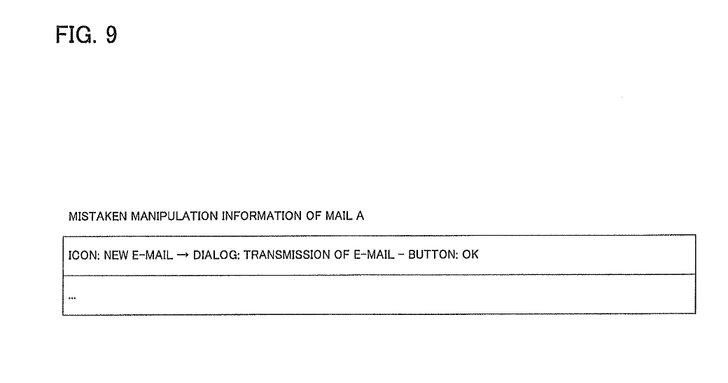

FIG. 9 is a figure showing an example of the mistaken manipulation information stored in the mistaken manipulation history memory part 41.

With reference to FIG. 9, the mistaken manipulation history memory part 41 stores the mistaken manipulation information for every system 400. Here, stored is the mistaken manipulation procedure indicated in FIG. 7 which is the above-mentioned mistaken manipulation of “transmitting without specifying a destination e-mail address”.

### [GUI Manipulation Assistance]

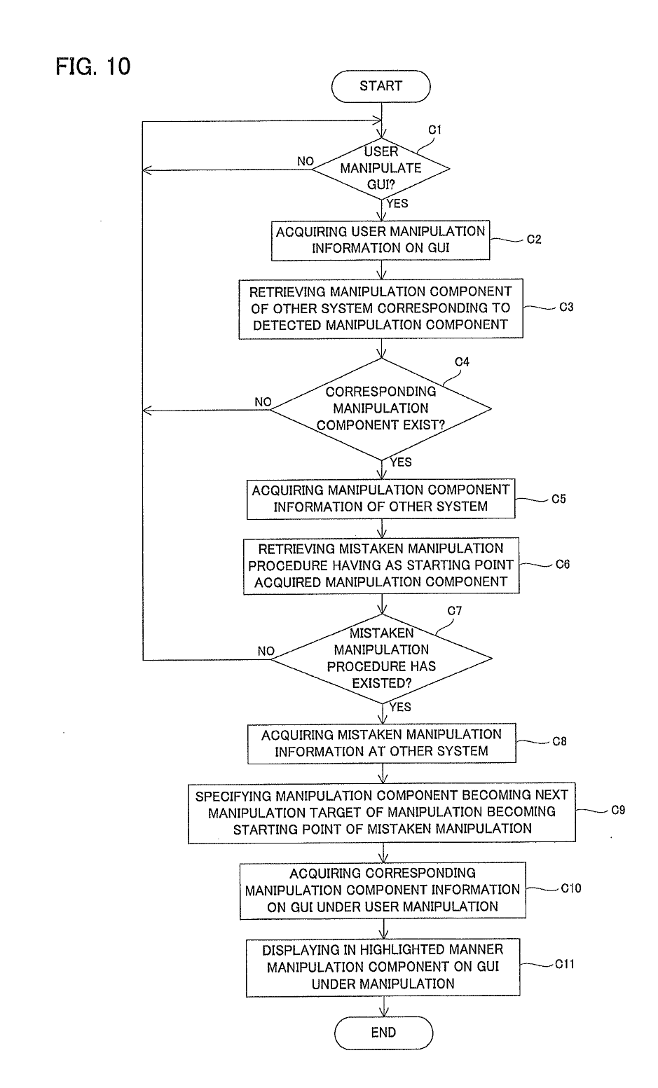

Then, using FIG. 10, a operation in which performed is the GUI manipulation assistance will be described.

FIG. 10 is a flow chart showing a operation procedure in the case where the information processing device according to the first embodiment of the present invention assists a user's GUI manipulation. Here, a case where a user manipulates a GUI of an e-mail application Mail B will be described.

With reference to FIG. 10, first, since operations of steps C1 and C2 are the same as operations shown in steps A1 and A2 in FIG. 3, detailed descriptions are not repeated here.

Then, the manipulation detection part 20 outputs the acquired manipulation information to the mistaken manipulation history determination part 60. That is, the manipulation detection part 20, while storing the acquired manipulation information in the manipulation history memory part 21 (Step A3 of FIG. 3), outputs the acquired manipulation information also to the mistaken manipulation history determination part 60.

Then, the mistaken manipulation history determination part 60, with reference to the manipulation component information table which the manipulation component information memory part 50 has stored, retrieves a manipulation component of systems 400 other than the target system, which corresponds to the manipulation component of the target system which the manipulation information received from the manipulation detection part 20 indicates (Step C3).

The mistaken manipulation history determination part 60, in the case where there is no corresponding manipulation component (NO at Step C4), continues monitoring the information processing device 201.

On the other hand, the mistaken manipulation history determination part 60, in the case where there are corresponding manipulation components (YES at Step C4), acquires the manipulation component information indicating the manipulation component (Step C5).

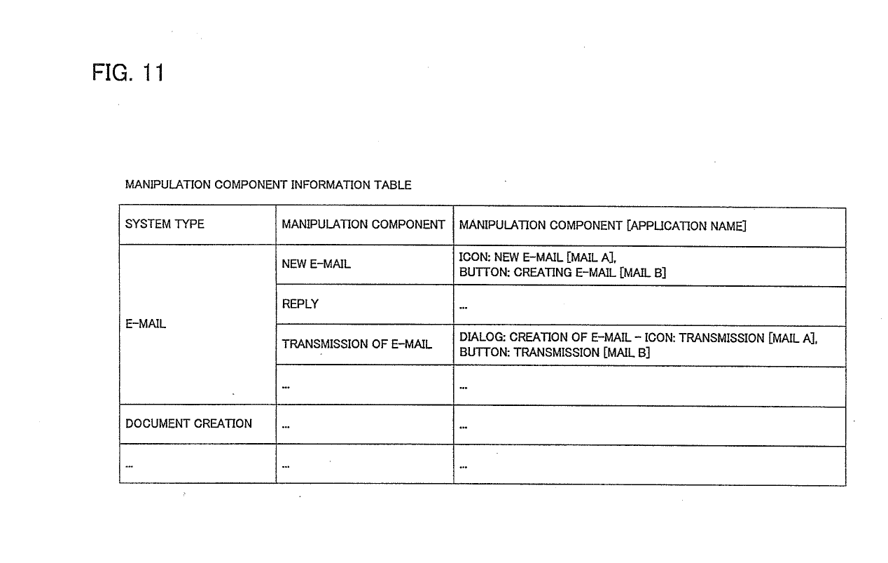

FIG. 11 is a figure showing an example of a manipulation component information table.

With reference to FIG. 11, as for the manipulation component information table, types of manipulation components and manipulation components of a GUI of each system are registered for every type of systems 400.

Here, an e-mail system as a system type, and “New e-mail” and “Transmission of an e-mail” or the like as manipulation components thereof, are registered. Then, in “New e-mail”, “Icon: New e-mail” as the manipulation component of the e-mail application Mail A, and “Button: Creating an e-mail” as the manipulation component of the e-mail application Mail-B are registered. In addition, in “Transmission of an e-mail”, “Dialog: Creating an e-mail—Icon: Transmission” as the manipulation component of the e-mail application Mail A, and “Button: Transmission” as the manipulation component of the e-mail application Mail B are registered.

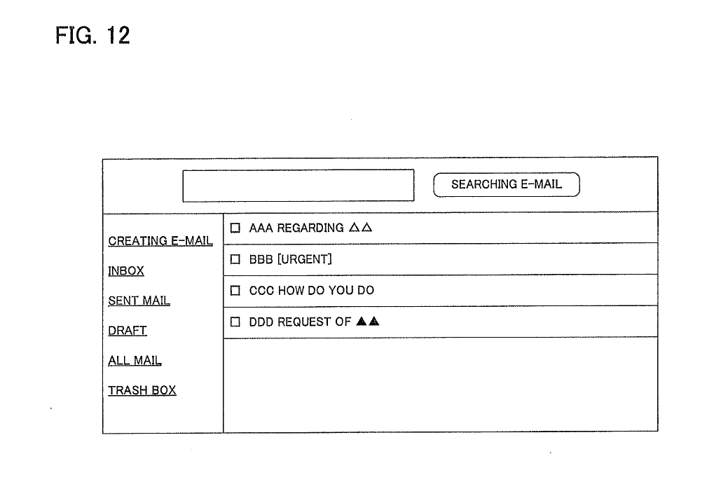

FIG. 12 is a figure showing an example of a GUI which the e-mail application Mail B provides.

With reference to FIG. 12, for example, it is assumed that a user manipulates a GUI of the e-mail application Mail B such as shown in FIG. 12 to create a new e-mail.

A user depresses a “Creating an e-mail” button on the GUI. Then, the manipulation detection part 20 detects the GUI manipulation to the e-mail application Mail B, and acquires “Button: Creating an e-mail” as the manipulation information.

Then, the mistaken manipulation history determination part 60, using the manipulation information “Button: Creating an e-mail” to the e-mail application Mail B, searches the manipulation component information table indicated in FIG. 11, and acquires the manipulation component information “Icon: New e-mail” on the e-mail application Mail A.

Again with reference to FIG. 10, then, the mistaken manipulation history determination part 60, with reference to the mistaken manipulation information stored in the mistaken manipulation history memory part 41, retrieves a mistaken manipulation procedure having as a starting point the manipulation component which the acquired manipulation component information indicates (Step C6).

Then, the mistaken manipulation history determination part 60, in the case where there is no mistaken manipulation procedure having as a starting point the manipulation component (NO at Step C7), continues monitoring the information processing device 201.

On the other hand, the mistaken manipulation history determination part 60, in the case where there is mistaken manipulation procedure having as a starting point the manipulation component (YES at Step C7), acquires the mistaken manipulation information (Step C8). Then, the mistaken manipulation history determination part 60 outputs the acquired mistaken manipulation information to the corresponding-manipulation component determination part 70.

In the case of examples shown in FIG. 5, FIG. and FIG. 9, the mistaken manipulation history determination part 60, using the acquired manipulation information “Icon: New e-mail” to the e-mail application Mail A, refers to the mistaken manipulation information stored in the mistaken manipulation history memory part 41 shown in FIG. 9. Then, the mistaken manipulation history determination part 60 acquires the mistaken manipulation information “Icon: New e-mail→Dialog: Transmission of an e-mail—Button: OK”, which has “Icon: New e-mail” as a starting point.

Then, the corresponding-manipulation component determination part 70, from the mistaken manipulation information received from the mistaken manipulation history determination part 60, specifies a manipulation after the manipulation becoming the starting point of the mistaken manipulation, for example, a manipulation component becoming a target of a next manipulation of the manipulation becoming the starting point of the mistaken manipulation (Step C9).

In the case of examples shown in FIG. 5, FIG. 7 and FIG. 9, the corresponding-manipulation component determination part 70, from mistaken manipulation information “Icon: New e-mail→Dialog: Transmission of an e-mail—Button: OK”, specifies “Dialog: Transmission of an e-mail—Button: OK” as the manipulation component becoming the target of the next manipulation of the manipulation component “Icon: New e-mail” becoming the target of the manipulation becoming the starting point of the mistaken manipulation.

Then, the corresponding-manipulation component determination part 70, with reference to the manipulation component information table stored in the manipulation component information memory part 50, acquires the manipulation component information indicating the manipulation component on the GUI in the target system, which corresponds to the specified manipulation component (Step C10). Then, the corresponding-manipulation component determination part 70 outputs the acquired manipulation component information to the corresponding-manipulation component display part 80.

In the case of examples shown in FIG. 5, FIG. 7 and FIG. 9, the corresponding-manipulation component determination part 70, with reference to the manipulation component information table shown in FIG. 11, acquires the manipulation component information of the e-mail application Mail B “Button: Transmission”, which corresponds to the manipulation component “Transmission of an e-mail” in the specified manipulation component information “Dialog: Transmission of an e-mail—Button: OK” of the e-mail application Mail A.

Then, the corresponding-manipulation component display part 80 displays the manipulation component on the GUI in the target system which the manipulation component information received from the corresponding-manipulation component determination part 70 indicates, on a screen of the output device 203 in a highlighted manner so that a user may not manipulate it accidentally (Step C11).

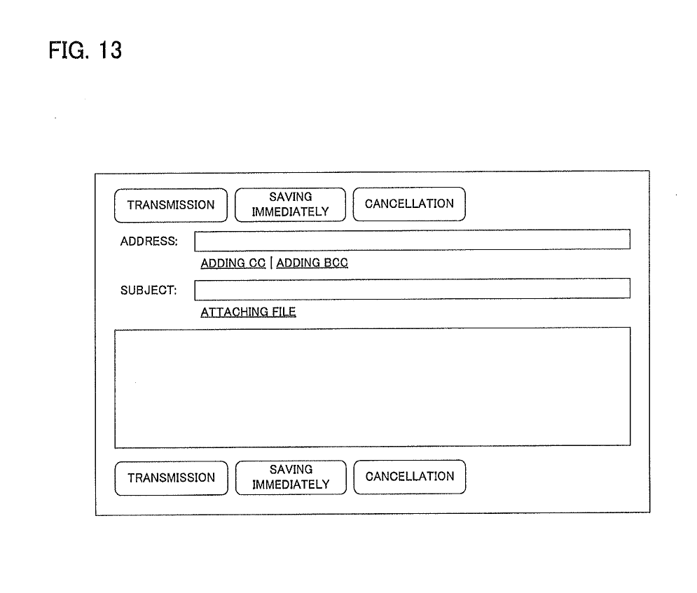

FIG. 13 is a figure showing an example of a GUI which the e-mail application Mail B provides.

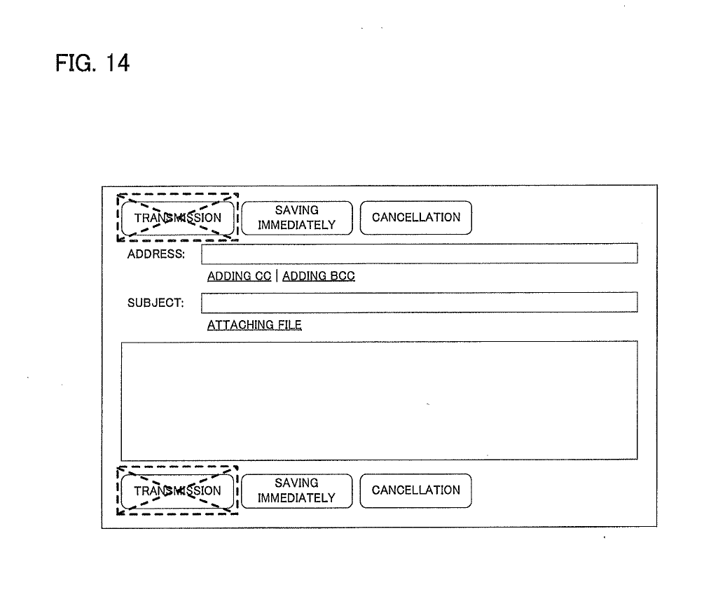

FIG. 14 is a figure showing an example of highlighting the manipulation component in the information processing device according to the first embodiment of the present invention.

In the case of examples shown in FIG. 5, FIG. 7 and FIG. 9, it is assumed that in the case where “Button: Creating an e-mail” is depressed on the GUI of the e-mail application Mail B shown in FIG. 12, the screen as shown in FIG. 13 is displayed in a switched manner. In this case, the corresponding-manipulation component display part 80 displays the manipulation component “Button: Transmission” in a highlighted manner as shown in FIG. 14 so that a user may not manipulate the manipulation component accidentally.

Then, the corresponding-manipulation component display part 80 deletes the highlighted display after a certain period of time, or deletes when a next new manipulation is detected.

Besides, as a method of highlighting, with messages to a user registered in advance for every pattern definition in the mistaken manipulation pattern table, the corresponding-manipulation component display part 80 may be made to display the registered messages. Thereby, it is possible to display an appropriate message for every mistaken manipulation pattern, and to display a correct manipulation procedure.

By the way, in the system described in Patent Document 1, an application provider side must prepare a plurality of GUIs in advance, and a process becomes complicated, and it is impossible to assist a user so that the user may not commit from now on a mistaken manipulation which has been actually committed by the user.

In addition, in the technologies described in Patent Documents 2, 4, and 5, since only a manipulation assistance in one system is taken into consideration, it is impossible to assist a manipulation to corresponding GUIs among a plurality of systems.

In addition, in the method described in Patent Document 3, it is necessary to register a use application and a manipulation procedure thereof in advance for every software program, and a process may have become complicated.

In contrast to these, in the information processing device according to the first embodiment of the present invention, the manipulation detection part 20 detects a GUI manipulation which is a manipulation to the GUI of the target system. The mistaken manipulation history memory part 41 stores one or more types of mistaken manipulation procedures that are past erroneous manipulation procedures to GUIs of one or more of systems 400 other than the target system. The mistaken manipulation history determination part 60, from among one or more types of mistaken manipulation procedures which the mistaken manipulation history memory part 41 stores, acquires the GUI manipulation in systems 400 other than the target system corresponding to the target GUI manipulation that is the GUI manipulation detected by the manipulation detection part 20, for example, the mistaken manipulation procedure having as a starting point the corresponding GUI manipulation that is the GUI manipulation equivalent to the target GUI manipulation. Then, the corresponding-manipulation component determination part 70, from mistaken manipulation procedure acquired by the mistaken manipulation history determination part 60, extracts the GUI manipulation in systems 400 other than the target system after the corresponding GUI manipulation becoming a starting point, and acquires the GUI manipulation in the target system corresponding to the extracted GUI manipulation.

In this manner, the information processing device according to the first embodiment of the present invention determines an existence of a past mistaken manipulation from the detected user's GUI manipulation, and in the case where there has been the same mistaken manipulation, specifies the manipulation component which has become the starting point of the mistaken manipulation, and in the system which is currently under the manipulation, assists a user so that the user may not manipulate a manipulation component becoming a factor resulting in a mistaken manipulation.

Base on such configurations, it is possible to assist a manipulation so that the user may not commit the same mistaken manipulation as the user has actually committed in the past.

In addition, in the information processing device according to the first embodiment of the present invention, the same manipulation components are made to be associated with each other among GUIs of different systems. That is, while a user manipulates the GUI of the target system, determined is an existence of the mistaken manipulation in the manipulation history to GUIs of systems other than the target system, which is associated with the detected user's GUI manipulation. Then, in the case where there is the mistaken manipulation, a manipulation component corresponding to the manipulation component after the manipulation which has become the starting point of the mistaken manipulation in systems other than the target system is specified from the manipulation component of the target system, and this is made to be displayed in a highlighted manner.

Base on such configurations, even if a user has not committed a mistaken manipulation in the past in the manipulation to the GUI of the target system which is currently under the manipulation, if the user has committed a mistaken manipulation in the past in systems other than the target system, it is possible to assist user's manipulation so that the user may not commit the same mistaken manipulation to the GUI of the target system.

That is, in the information processing device according to the first embodiment of the present invention, it is possible to assist a user who manipulates for the first time a GUI of an application which the user has not used until now, or to assist user's manipulation which needs to use and manipulate in a different manner a GUI of a system which is different but is of the same kind, and a GUI of a system which is the same system but is different in versions.

In addition, in the information processing device according to the first embodiment of the present invention, since it is not necessary for an application provider side to prepare a plurality of GUIs in advance and it is not necessary to have registered a use application and its manipulation procedure for every software program in advance, it is possible to prevent processes from becoming complicated.

That is, among constituents of the information processing device 201 according to the first embodiment of the present invention, based on the minimum configuration which is made up of the manipulation detection part 20, the mistaken manipulation history memory part 41, the mistaken manipulation history determination part 60, and the corresponding-manipulation component determination part 70, it becomes possible to achieve the object of the present invention that a manipulation to corresponding GUIs among a plurality of systems is assisted satisfactory by a simple process.

In addition, in the information processing device according to the first embodiment of the present invention, the corresponding-manipulation component display part 80 presents to a user in a highlighted manner the manipulation component corresponding to the GUI manipulation in the target system, which is acquired by the corresponding-manipulation component determination part 70.

Base on such configurations, an attention of a user who is under a manipulation to the target system is evoked, and it becomes possible to prevent the mistaken manipulation more surely.

Besides, the information processing device according to the first embodiment of the present invention has been made to have the configuration in which the mistaken manipulation history determination part 60, from among one or more types of mistaken manipulation procedures which the mistaken manipulation history memory part 41 stores, acquires the mistaken manipulation procedure having as a starting point the GUI manipulation in systems 400 other than the target system, which corresponds to the target GUI manipulation, and however, it is not limited to this. The mistaken manipulation history determination part 60, from among one or more types of mistaken manipulation procedures which the mistaken manipulation history memory part 41 stores, may be configured so as to acquire mistaken manipulation procedure including a corresponding GUI manipulation. However, based on the configuration which acquires the mistaken manipulation procedure having as a starting point the GUI manipulation in systems 400 other than the target system, which corresponds to the target GUI manipulation, it becomes possible to acquire the appropriate mistaken manipulation information and to prevent the mistaken manipulation of the user more surely.

In addition, the information processing device according to the first embodiment of the present invention has been made to have the configuration in which the corresponding-manipulation component display part 80 displays, on a screen of the output device 203, the manipulation component corresponding to the GUI manipulation in the target system which has been acquired by corresponding-manipulation component determination part 70 and however, it is not limited to this. The corresponding-manipulation component display part 80 presents to a user the manipulation component in a highlighted manner by other certain means.

Next, an other embodiment of the present invention will be described using the figures. It is noted that the same reference character will be is given to the same or corresponding part in the figures, and thus the description will not be repeated.

### Second Embodiment

The present embodiment relates to an information processing device to which added is a process in the case where the mistaken manipulation history determination part 60 acquires a plurality of mistaken manipulation procedures as compared with the information processing device according to the first embodiment of the present invention. The contents other than described in the following are the same as those of the information processing device according to the first embodiment.

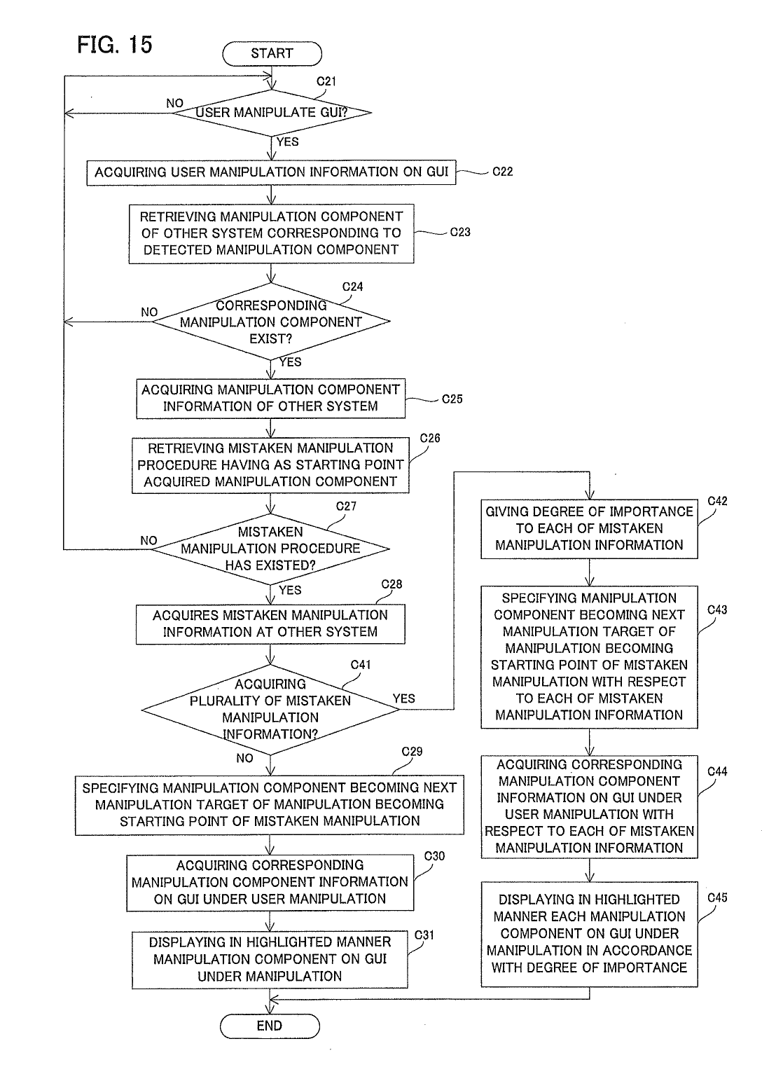

FIG. 15 is a flow chart showing a operation procedure in the case where the information processing device according to the second embodiment of the present invention detects a mistaken manipulation.

Since Steps C21 to C31 shown in FIG. 15 are the same as Steps C1 to C11 of the flow chart shown in FIG. 10, the detailed descriptions thereof are not repeated here.

With reference to FIG. 15, the mistaken manipulation history determination part 60, with reference to the mistaken manipulation information stored in the mistaken manipulation history memory part 41, in the case where a plurality of mistaken manipulation procedures having as a starting point the manipulation component acquired from the manipulation component information memory part 50 exist (YES at Step C41), acquires a plurality of mistaken manipulation information corresponding to these plurality of the mistaken manipulation procedures.

Then, the mistaken manipulation history determination part 60 gives a degree of importance each to the acquired plurality of mistaken manipulation information.

That is, the mistaken manipulation history determination part 60, in the case of having acquired a plurality of mistaken manipulation procedures from among one or more types of mistaken manipulation procedures which the mistaken manipulation history memory part 41 stores, gives a degree of importance to each acquired mistaken manipulation procedure (Step C42).

As methods of giving the degree of importance, the following three methods can be considered, for example. That is, the mistaken manipulation history determination part 60, with respect to each acquired mistaken manipulation procedure, gives the more recently generated mistaken manipulation procedure the higher degree of importance.

Alternatively, the mistaken manipulation history determination part 60, with respect to each acquired mistaken manipulation procedure, gives the mistaken manipulation procedure having the more generation frequency the higher degree of importance.

Alternatively, the mistaken manipulation history determination part 60, with respect to each acquired mistaken manipulation procedure, gives the mistaken manipulation procedure generated in the more systems 400 other than the target system the higher degree of importance.

Then, the mistaken manipulation history determination part 60 outputs the acquired plurality of mistaken manipulation information to the corresponding-manipulation component determination part 70.

Then, the corresponding-manipulation component determination part 70, from the plurality of mistaken manipulation information received from the mistaken manipulation history determination part 60, each specifies a manipulation after the manipulation becoming the starting point of the mistaken manipulation, for example, a manipulation component becoming a target of a next manipulation of the manipulation becoming the starting point of the mistaken manipulation (Step C43).

Then, the corresponding-manipulation component determination part 70, with reference to the manipulation component information table stored in the manipulation component information memory part 50, each acquires the manipulation component information indicating the manipulation component on the GUI in the target system, which corresponds to each of the specified plurality of manipulation components (Step C44). Then, the corresponding-manipulation component determination part outputs each acquired manipulation component information to the corresponding-manipulation component display part 80.

Then, the corresponding-manipulation component display part 80 displays the manipulation component on the GUI in the target system which each manipulation component information received from the corresponding-manipulation component determination part 70 indicates, on a screen of the output device 203 in a highlighted manner so that a user may not manipulate it accidentally (Step C45).

In more details, the corresponding-manipulation component display part 80, among each manipulation component information acquired by the corresponding-manipulation component determination part 70, i.e., each GUI manipulation in the target system, presents the manipulation component corresponding to the GUI manipulation included in the mistaken manipulation procedure having the higher degree of importance in the more highlighted manner.

In addition, the corresponding-manipulation component display part 80, among each GUI manipulation in the target system acquired by the corresponding-manipulation component determination part 70, does not present in a highlighted manner the manipulation component corresponding the GUI manipulation included in the mistaken manipulation procedure of which the degree of importance is less than a prescribed level.

That is, the corresponding-manipulation component display part 80, among each GUI manipulation in the target system acquired by the corresponding-manipulation component determination part 70, presents the manipulation component corresponding to the GUI manipulation included in the mistaken manipulation procedure of which the degree of importance is within a prescribed range in a highlighted manner, and presents the manipulation component corresponding to the GUI manipulation included in the mistaken manipulation procedure having the higher degree of importance in the more highlighted manner.

In this manner, the corresponding-manipulation component display part 80 displays the manipulation component of which the level of the degree of importance is in a prescribed range in a highlighted manner in incremental steps depending on the level of the degree of importance. By adjusting this prescribed range, it is also possible to display the manipulation components corresponding to all the acquired GUI manipulations in a highlighted manner in incremental steps depending on the level of the degree of importance.

As examples of the highlighted display in incremental steps, for example, the corresponding-manipulation component display part 80, in the screen of the output device 203, displays the manipulation component having the higher degree of importance in the deeper color, and displays the manipulation component having the lower degree of importance in the lighter color. Alternatively, the corresponding-manipulation component display part 80 displays the manipulation component having the higher degree of importance with the thicker line, and displays the manipulation component having the lower degree of importance with the thinner line.

Consequently, in the information processing device according to the second embodiment of the present invention, even in the case where a plurality of mistaken manipulation procedures are acquired from the user's GUI manipulation in the target system, and a plurality of manipulation components resulting in a factor of the mistaken manipulation exist, it is possible to perform. the GUI manipulation assistance appropriately.

Since other configurations and operations are the same as those of the linkage information output apparatus according to the first embodiment, detailed descriptions are not repeated here.

A part or all of the above-mentioned embodiments are described also as the following additional statements, and however, the scope of the present invention is not limited to the following additional statements.

### [Additional Statement 1]

An information processing device for assisting a user who manipulates a GUI (Graphical User Interface), comprising:
a manipulation detection part configured to detect a GUI manipulation that is a manipulation to a GUI of a first system;
a mistaken manipulation history memory part configured to store one or more types of mistaken manipulation procedures that are past mistaken manipulation procedures to GUIs of one or more second systems;
a mistaken manipulation history determination part configured to acquire said mistaken manipulation procedure including a corresponding GUI manipulation that is a GUI manipulation in said second system corresponding to a target GUI manipulation that is said GUI manipulation detected by said manipulation detection part from among said one or more types of mistaken manipulation procedures which said mistaken manipulation history memory part stores; and
a corresponding-manipulation acquisition part configured to extract a GUI manipulation in said second system after said corresponding GUI manipulation from said mistaken manipulation procedure acquired by said mistaken manipulation history determination part, and configured to acquire a GUI manipulation in said first system corresponding to extracted said GUI manipulation.

### [Additional Statement 2]

The information processing device according to Additional statement 1, wherein
said mistaken manipulation history determination part, from among said one or more types of mistaken manipulation procedures which said mistaken manipulation history memory part stores, acquires said mistaken manipulation procedure having as a starting point said corresponding GUI manipulation, and
said corresponding-manipulation acquisition part, from said mistaken manipulation procedure acquired by said mistaken manipulation history determination part, extracts a GUI manipulation in said second system after said corresponding GUI manipulation becoming said starting point and acquires a GUI manipulation in said first system corresponding to extracted said GUI manipulation.

### [Additional Statement 3]

The information processing device according to Additional statements 1 or 2, wherein
said information processing device further comprises a corresponding-manipulation component display part configured to present in a highlighted manner to a user a manipulation component corresponding to a GUI manipulation in said first system acquired by said corresponding-manipulation acquisition part.

### [Additional Statement 4]

The information processing device according to any of Additional statements 1 to 3, wherein said mistaken manipulation history determination part, in the case of acquiring a plurality of said mistaken manipulation procedures including said corresponding GUI manipulation from among said one or more types of mistaken manipulation procedures which said mistaken manipulation history memory part stores, gives a degree of importance to acquired each said mistaken manipulation procedure.

### [Additional Statement 5]

The information processing device according to Additional statement 4, wherein
said mistaken manipulation history determination part, with respect to acquired each said mistaken manipulation procedure, gives the more recently generated said mistaken manipulation procedure the higher degree of importance.

### [Additional Statement 6]

The information processing device according to Additional statement 4, wherein
said mistaken manipulation history determination part, with respect to acquired each said mistaken manipulation procedure, gives said mistaken manipulation procedure having the more generation frequency the higher degree of importance.

### [Additional Statement 7]

The information processing device according to Additional statement 4, wherein
said mistaken manipulation history determination part, with respect to acquired each said mistaken manipulation procedure, gives said mistaken manipulation procedure generated in the more said second systems the higher degree of importance.

### [Additional Statement 8]

The information processing device according to any of Additional statements 4 to 7, wherein
said corresponding-manipulation component display part, among GUI manipulations in said first system acquired by said corresponding-manipulation acquisition part, presents in a highlighted manner a manipulation component corresponding to said GUI manipulation included in said mistaken manipulation procedure in which said degree of importance is in a prescribed range, and presents a manipulation component corresponding to said GUI manipulation included in said mistaken manipulation procedure having the higher said degree of importance in the more highlighted manner.

### [Additional Statement 9]

The information processing device according to any of Additional statements 4 to 7, wherein
said corresponding-manipulation component display part, among GUI manipulations in said first system acquired by said corresponding-manipulation acquisition part, presents a manipulation component corresponding to said GUI manipulation included in said mistaken manipulation procedure having the higher said degree of importance in the more highlighted manner.

### [Additional Statement 10]

The information processing device according to Additional statement 9, wherein
said corresponding-manipulation component display part, among GUI manipulations in said first system acquired by said corresponding-manipulation acquisition part, does not present in a highlighted manner a manipulation component corresponding said GUI manipulation included in said mistaken manipulation procedure of which said degree of importance is less than a prescribed level.

### [Additional Statement 11]

A GUI manipulation assistance method which assists a user who manipulates a GUI of a first system, comprising the steps of:
storing one or more types of mistaken manipulation procedures that are past mistaken manipulation procedures to GUIs of one or more second systems;
detecting a GUI manipulation that is a manipulation to a GUI of said first system;
acquiring said mistaken manipulation procedure including a corresponding GUI manipulation that is a GUI manipulation in said second system corresponding to a target GUI manipulation that is detected said GUI manipulation, from among stored said one or more types of mistaken manipulation procedures; and
extracting a GUI manipulation in said second system after said corresponding GUI manipulation from acquired said mistaken manipulation procedure, and acquiring a GUI manipulation in said first system corresponding to extracted said GUI manipulation.

### [Additional Statement 12]

The GUI manipulation assistance method according to Additional statement 11, which
in a step of acquiring said mistaken manipulation procedure, from among stored said one or more types of mistaken manipulation procedures, acquires said mistaken manipulation procedure having as a starting point said corresponding GUI manipulation, and
in a step of acquiring said GUI manipulation, from acquired said mistaken manipulation procedure, extracts a GUI manipulation in said second system after said corresponding GUI manipulation becoming said starting point, and acquires a GUI manipulation in said first system corresponding to extracted said GUI manipulation.

### [Additional Statement 13]

The GUI manipulation assistance method according to Additional statements 11 or 12, wherein
said GUI manipulation assistance method further comprises
a step of presenting in a highlighted manner to a user a manipulation component corresponding to acquired GUI manipulation in said first system.

### [Additional Statement 14]

The GUI manipulation assistance method according to any of Additional statements 11 to 13, which
in a step of acquiring said mistaken manipulation procedure, in the case of acquiring a plurality of said mistaken manipulation procedures including said corresponding GUI manipulation from among stored said one or more types of mistaken manipulation procedures, gives acquired each said mistaken manipulation procedure a degree of importance.

### [Additional Statement 15]

The GUI manipulation assistance method according to Additional statement 14, which
in a step of acquiring said mistaken manipulation procedure, with respect to acquired each said mistaken manipulation procedure, gives the more recently generated said mistaken manipulation procedure the higher degree of importance.

### [Additional Statement 16]

The GUI manipulation assistance method according to Additional statement 14, which
in a step of acquiring said mistaken manipulation procedure, with respect to acquired each said mistaken manipulation procedure, gives said mistaken manipulation procedure having the more generation frequency the higher degree of importance.

### [Additional Statement 17]

The GUI manipulation assistance method according to Additional statement 14, which
in a step of acquiring said mistaken manipulation procedure, with respect to acquired each said mistaken manipulation procedure, gives said mistaken manipulation procedure generated in the more said second systems the higher degree of importance.

### [Additional Statement 18]

The GUI manipulation assistance method according to any of Additional statements 14 to 17, which
in a step of presenting said manipulation component to a user, among acquired GUI manipulations in said first system, presents in a highlighted manner a manipulation component corresponding to said GUI manipulation included in said mistaken manipulation procedure in which said degree of importance is in a prescribed range, and presents a manipulation component corresponding to said GUI manipulation included in said mistaken manipulation procedure having the higher said degree of importance in the more highlighted manner.

### [Additional Statement 19]

The GUI manipulation assistance method according to any of Additional statements 14 to 17, which in a step of presenting said manipulation component to a user, among acquired GUI manipulations in said first system, presents a manipulation component corresponding to said GUI manipulation included in said mistaken manipulation procedure having the higher said degree of importance in the more highlighted manner.

### [Additional Statement 20]

The GUI manipulation assistance method according to Additional statement 19, which
in a step of presenting said manipulation component to a user, among acquired GUI manipulations in said first system, does not present in a highlighted manner a manipulation component corresponding said GUI manipulation included in said mistaken manipulation procedure of which said degree of importance is less than a prescribed level.

### [Additional Statement 21]

A computer-readable recording medium in which a GUI manipulation assistance program used in an information processing device for assisting a user who manipulates a GUI of a first system is recorded, said GUI manipulation assistance program being a program making a computer execute the steps of:
storing one or more types of mistaken manipulation procedures that are past mistaken manipulation procedures to GUIs of one or more second systems;
detecting a GUI manipulation that is a manipulation to a GUI of said first system;
acquiring said mistaken manipulation procedure including a corresponding GUI manipulation that is a GUI manipulation in said second system corresponding to a target GUI manipulation that is detected said GUI manipulation, from among stored said one or more types of mistaken manipulation procedures; and
extracting a GUI manipulation in said second system after said corresponding GUI manipulation from among acquired said mistaken manipulation procedure, and acquiring a GUI manipulation in said first system corresponding to extracted said GUI manipulation.

### [Additional Statement 22]

The computer-readable recording medium according to Additional statement 21, which
in a step of acquiring said mistaken manipulation procedure, from among stored said one or more types of mistaken manipulation procedures, acquires said mistaken manipulation procedure having as a starting point said corresponding GUI manipulation, and
in a step of acquiring said GUI manipulation, from acquired said mistaken manipulation procedure, extracts a GUI manipulation in said second system after said corresponding GUI manipulation becoming said starting point, and acquires a GUI manipulation in said first system corresponding to extracted said GUI manipulation.

### [Additional Statement 23]

The computer-readable recording medium according to Additional statements 21 or 22, wherein
said GUI manipulation assistance program is a program for making a computer further execute a step of presenting in a highlighted manner to a user a manipulation component corresponding to acquired GUI manipulation in said first system.

### [Additional Statement 24]

The computer-readable recording medium according to any of Additional statements 21 to 23, which
in a step of acquiring said mistaken manipulation procedure, in the case of acquiring a plurality of said mistaken manipulation procedures including said corresponding GUI manipulation from among stored said one or more types of mistaken manipulation procedures, gives a degree of importance to acquired each said mistaken manipulation procedure.

### [Additional Statement 25]

The computer-readable recording medium according to Additional statement 24, which
in a step of acquiring said mistaken manipulation procedure, with respect to acquired each said mistaken manipulation procedure, gives the more recently generated said mistaken manipulation procedure the higher degree of importance.

### [Additional Statement 26]

The computer-readable recording medium according to Additional statement 24, which
in a step of acquiring said mistaken manipulation procedure, with respect to acquired each said mistaken manipulation procedure, gives said mistaken manipulation procedure having the more generation frequency the higher degree of importance.

### [Additional Statement 27]

The computer-readable recording medium according to Additional statement 24, which
in a step of acquiring said mistaken manipulation procedure, with respect to acquired each said mistaken manipulation procedure, gives said mistaken manipulation procedure generated in the more said second systems the higher degree of importance.

### [Additional Statement 28]

The computer-readable recording medium according to any of Additional statements 24 to 27, which
in a step of presenting said manipulation component to a user, among acquired GUI manipulations in said first system, presents in a highlighted manner a manipulation component corresponding to said GUI manipulation included in said mistaken manipulation procedure in which said degree of importance is in a prescribed range, and presents a manipulation component corresponding to said GUI manipulation included in said mistaken manipulation procedure having the higher said degree of importance in the more highlighted manner.

### [Additional Statement 29]

The computer-readable recording medium according to any of Additional statements 24 to 27, which
in a step of presenting said manipulation component to a user, among acquired GUI manipulations in said first system, presents a manipulation component corresponding to said GUI manipulation included in said mistaken manipulation procedure having the higher said degree of importance in the more highlighted manner.

### [Additional Statement 30]

The computer-readable recording medium according to Additional statement 29, which
in a step of presenting said manipulation component to a user, among acquired GUI manipulations in said first system, does not present in a highlighted manner a manipulation component corresponding said GUI manipulation included in said mistaken manipulation procedure of which said degree of importance is less than a prescribed level.

Above-mentioned embodiments should be considered to an exemplification at all points, and not restrictive. The scope of the present invention is shown not by descriptions mentioned above but by the scope of the claims, and all modifications within meaning and scope equivalent to the claims are intended to be included therein.

This application claims priority on the basis of Japanese Patent Application No. 2010-122316 applied on May 28, 2010, and takes inhere all the disclosures thereof.

### INDUSTRIAL APPLICABILITY

The present invention is applicable to an information processing device where a user manipulates GUIs of a plurality of systems. In particular, the present invention is applicable to the information processing device in which a user uses and manipulates in a different manner a plurality of systems which are of the same kind, but different, and uses and manipulates in a different manner systems which are the same, but different in versions, and so on. Therefore, the present invention has industrial applicability.

### DESCRIPTION OF SYMBOLS

10 Gui Manipulation Assistance System

20 Manipulation Detection Part

21 Manipulation History Memory Part

30 Mistaken Manipulation Pattern Memory Part

40 Mistaken Manipulation Detection Part

41 Mistaken Manipulation History Memory Part

50 Manipulation Component Information Memory Part

60 Mistaken Manipulation History Determination Part

70 Corresponding-Manipulation Component Determination Part

80 Corresponding-Manipulation Component Display Part

101 CPU

102 Main memory

103 Hard disk

104 Input interface

105 Display controller

106 Data reader/writer

107 Communication interface

108 Keyboard

109 Mouse

110 Display

111 Recording medium

121 Bus

201 Information Processing Device

202 Input Device

203 Output Device

400 System

501 Main Screen

502 “Creating an e-mail” Dialog

503 Error Dialog

1-10. (canceled)

11. An information processing device for assisting a user who manipulates a GUI (Graphical User Interface), comprising:
a manipulation detection part configured to detect a GUI manipulation that is a manipulation to a GUI of a first system;
a mistaken manipulation history memory part configured to store one or more types of mistaken manipulation procedures that are past mistaken manipulation procedures to GUIs of one or more second systems;
a mistaken manipulation history determination part configured to acquire said mistaken manipulation procedure including a corresponding GUI manipulation that is a GUI manipulation in said second system corresponding to a target GUI manipulation that is said GUI manipulation detected by said manipulation detection part from among said one or more types of mistaken manipulation procedures which said mistaken manipulation history memory part stores; and
a corresponding-manipulation acquisition part configured to extract a GUI manipulation in said second system after said corresponding GUI manipulation from said mistaken manipulation procedure acquired by said mistaken manipulation history determination part, and configured to acquire a GUI manipulation in said first system corresponding to extracted said GUI manipulation.

12. The information processing device according to claim 11, wherein
said mistaken manipulation history determination part, from among said one or more types of mistaken manipulation procedures which said mistaken manipulation history memory part stores, acquires said mistaken manipulation procedure having as a starting point said corresponding GUI manipulation, and
said corresponding-manipulation acquisition part, from said mistaken manipulation procedure acquired by said mistaken manipulation history determination part, extracts a GUI manipulation in said second system after said corresponding GUI manipulation becoming said starting point and acquires a GUI manipulation in said first system corresponding to extracted said GUI manipulation.

13. The information processing device according to claim 11, wherein
said information processing device further comprises
a corresponding-manipulation component display part configured to present in a highlighted manner to a user a manipulation component corresponding to a GUI manipulation in said first system acquired by said corresponding-manipulation acquisition part.

14. The information processing device according to claim 11, wherein
said mistaken manipulation history determination part, in the case of acquiring a plurality of said mistaken manipulation procedures including said corresponding GUI manipulation from among said one or more types of mistaken manipulation procedures which said mistaken manipulation history memory part stores, gives a degree of importance to acquired each said mistaken manipulation procedure.

15. The information processing device according to claim 14, wherein
said mistaken manipulation history determination part, with respect to acquired each said mistaken manipulation procedure, gives the more recently generated said mistaken manipulation procedure the higher degree of importance.

16. The information processing device according to claim 14, wherein
said mistaken manipulation history determination part, with respect to acquired each said mistaken manipulation procedure, gives said mistaken manipulation procedure having the more generation frequency the higher degree of importance.

17. The information processing device according to claim 14, wherein
said mistaken manipulation history determination part, with respect to acquired each said mistaken manipulation procedure, gives said mistaken manipulation procedure generated in the more said second systems the higher degree of importance.

18. The information processing device according to claim 14, wherein
said corresponding-manipulation component display part, among GUI manipulations in said first system acquired by said corresponding-manipulation acquisition part, presents in a highlighted manner a manipulation component corresponding to said GUI manipulation included in said mistaken manipulation procedure in which said degree of importance is in a prescribed range, and presents a manipulation component corresponding to said GUI manipulation included in said mistaken manipulation procedure having the higher said degree of importance in the more highlighted manner.

19. The information processing device according to claim 14, wherein
said corresponding-manipulation component display part, among GUI manipulations in said first system acquired by said corresponding-manipulation acquisition part, presents a manipulation component corresponding to said GUI manipulation included in said mistaken manipulation procedure having the higher said degree of importance in the more highlighted manner.

20. The information processing device according to claim 19, wherein
said corresponding-manipulation component display part, among GUI manipulations in said first system acquired by said corresponding-manipulation acquisition part, does not present in a highlighted manner a manipulation component corresponding said GUI manipulation included in said mistaken manipulation procedure of which said degree of importance is less than a prescribed level.

21. A GUI manipulation assistance method which assists a user who manipulates a GUI of a first system, comprising the steps of:
storing one or more types of mistaken manipulation procedures that are past mistaken manipulation procedures to GUIs of one or more second systems;
detecting a GUI manipulation that is a manipulation to a GUI of said first system;
acquiring said mistaken manipulation procedure including a corresponding GUI manipulation that is a GUI manipulation in said second system corresponding to a target GUI manipulation that is detected said GUI manipulation, from among stored said one or more types of mistaken manipulation procedures; and
extracting a GUI manipulation in said second system after said corresponding GUI manipulation from acquired said mistaken manipulation procedure, and acquiring a GUI manipulation in said first system corresponding to extracted said GUI manipulation.

22. The GUI manipulation assistance method according to claim 21, which
in a step of acquiring said mistaken manipulation procedure, from among stored said one or more types of mistaken manipulation procedures, acquires said mistaken manipulation procedure having as a starting point said corresponding GUI manipulation, and
in a step of acquiring said GUI manipulation, from acquired said mistaken manipulation procedure, extracts a GUI manipulation in said second system after said corresponding GUI manipulation becoming said starting point, and acquires a GUI manipulation in said first system corresponding to extracted said GUI manipulation.

23. The GUI manipulation assistance method according to claim 21, wherein
said GUI manipulation assistance method further comprises
a step of presenting in a highlighted manner to a user a manipulation component corresponding to acquired GUI manipulation in said first system.

24. The GUI manipulation assistance method according to any of claim 21, which
in a step of acquiring said mistaken manipulation procedure, in the case of acquiring a plurality of said mistaken manipulation procedures including said corresponding GUI manipulation from among stored said one or more types of mistaken manipulation procedures, gives acquired each said mistaken manipulation procedure a degree of importance.

25. The GUI manipulation assistance method according to claim 24, which
in a step of acquiring said mistaken manipulation procedure, with respect to acquired each said mistaken manipulation procedure, gives the more recently generated said mistaken manipulation procedure the higher degree of importance.

26. The GUI manipulation assistance method according to claim 24, which
in a step of acquiring said mistaken manipulation procedure, with respect to acquired each said mistaken manipulation procedure, gives said mistaken manipulation procedure having the more generation frequency the higher degree of importance.

27. The GUI manipulation assistance method according to claim 24, which
in a step of acquiring said mistaken manipulation procedure, with respect to acquired each said mistaken manipulation procedure, gives said mistaken manipulation procedure generated in the more said second systems the higher degree of importance.

28. The GUI manipulation assistance method according to claim 24, which
in a step of presenting said manipulation component to a user, among acquired GUI manipulations in said first system, presents in a highlighted manner a manipulation component corresponding to said GUI manipulation included in said mistaken manipulation procedure in which said degree of importance is in a prescribed range, and presents a manipulation component corresponding to said GUI manipulation included in said mistaken manipulation procedure having the higher said degree of importance in the more highlighted manner.

29. The GUI manipulation assistance method according to claim 24, which
in a step of presenting said manipulation component to a user, among acquired GUI manipulations in said first system, presents a manipulation component corresponding to said GUI manipulation included in said mistaken manipulation procedure having the higher said degree of importance in the more highlighted manner.

30. The GUI manipulation assistance method according to claim 29, which
in a step of presenting said manipulation component to a user, among acquired GUI manipulations in said first system, does not present in a highlighted manner a manipulation component corresponding said GUI manipulation included in said mistaken manipulation procedure of which said degree of importance is less than a prescribed level.

31. A computer-readable recording medium in which a GUI manipulation assistance program used in an information processing device for assisting a user who manipulates a GUI of a first system is recorded, said GUI manipulation assistance program being a program making a computer execute the steps of:
storing one or more types of mistaken manipulation procedures that are past mistaken manipulation procedures to GUIs of one or more second systems;
detecting a GUI manipulation that is a manipulation to a GUI of said first system;
acquiring said mistaken manipulation procedure including a corresponding GUI manipulation that is a GUI manipulation in said second system corresponding to a target GUI manipulation that is detected said GUI manipulation, from among stored said one or more types of mistaken manipulation procedures; and
extracting a GUI manipulation in said second system after said corresponding GUI manipulation from among acquired said mistaken manipulation procedure, and acquiring a GUI manipulation in said first system corresponding to extracted said GUI manipulation.

32. The computer-readable recording medium according to claim 31, which
in a step of acquiring said mistaken manipulation procedure, from among stored said one or more types of mistaken manipulation procedures, acquires said mistaken manipulation procedure having as a starting point said corresponding GUI manipulation, and
in a step of acquiring said GUI manipulation, from acquired said mistaken manipulation procedure, extracts a GUI manipulation in said second system after said corresponding GUI manipulation becoming said starting point, and acquires a GUI manipulation in said first system corresponding to extracted said GUI manipulation.

33. The computer-readable recording medium according to claim 31, wherein
said GUI manipulation assistance program is a program for making a computer further execute a step of presenting in a highlighted manner to a user a manipulation component corresponding to acquired GUI manipulation in said first system.

34. The computer-readable recording medium according to any of claim 31, which
in a step of acquiring said mistaken manipulation procedure, in the case of acquiring a plurality of said mistaken manipulation procedures including said corresponding GUI manipulation from among stored said one or more types of mistaken manipulation procedures, gives a degree of importance to acquired each said mistaken manipulation procedure.

35. The computer-readable recording medium according to claim 34, which
in a step of acquiring said mistaken manipulation procedure, with respect to acquired each said mistaken manipulation procedure, gives the more recently generated said mistaken manipulation procedure the higher degree of importance.

36. The computer-readable recording medium according to claim 34, which
in a step of acquiring said mistaken manipulation procedure, with respect to acquired each said mistaken manipulation procedure, gives said mistaken manipulation procedure having the more generation frequency the higher degree of importance.

37. The computer-readable recording medium according to claim 34, which
in a step of acquiring said mistaken manipulation procedure, with respect to acquired each said mistaken manipulation procedure, gives said mistaken manipulation procedure generated in the more said second systems the higher degree of importance.

38. The computer-readable recording medium according to claim 34, which
in a step of presenting said manipulation component to a user, among acquired GUI manipulations in said first system, presents in a highlighted manner a manipulation component corresponding to said GUI manipulation included in said mistaken manipulation procedure in which said degree of importance is in a prescribed range, and presents a manipulation component corresponding to said GUI manipulation included in said mistaken manipulation procedure having the higher said degree of importance in the more highlighted manner.

39. The computer-readable recording medium according to claim 34, which
in a step of presenting said manipulation component to a user, among acquired GUI manipulations in said first system, presents a manipulation component corresponding to said GUI manipulation included in said mistaken manipulation procedure having the higher said degree of importance in the more highlighted manner.

40. The computer-readable recording medium according to claim 39, which
in a step of presenting said manipulation component to a user, among acquired GUI manipulations in said first system, does not present in a highlighted manner a manipulation component corresponding said GUI manipulation included in said mistaken manipulation procedure of which said degree of importance is less than a prescribed level.
